(19) United States
(12) Patent Application Publication
(10) Pub. No.: US 2024/0317316 A1
(43) Pub. Date: Sep. 26, 2024

(54) CAR PANEL STRUCTURE

(71) Applicant: Honda Motor Co., Ltd., Tokyo (JP)

(72) Inventors: Kenta YAMAGISHI, Tokyo (JP); Takeki JUNIBAYASHI, Tokyo (JP); Futoshi MATSUDA, Tokyo (JP); Yota EGUCHI, Tokyo (JP); Mitsuhiro KANAFUKI, Tokyo (JP); Akihisa MATSUDA, Tokyo (JP); Arisa KANAZAWA, Tokyo (JP); Hiroshi KOBORI, Tokyo (JP)

(73) Assignee: Honda Motor Co., Ltd., Tokyo (JP)

(21) Appl. No.: 18/583,762

(22) Filed: Feb. 21, 2024

(30) Foreign Application Priority Data
Mar. 20, 2023 (CN) 202310271606.8

(51) Int. Cl. B62D 25/00; B62D 27/02

(52) U.S. Cl. CPC B62D 25/00; B62D 27/026

(57) ABSTRACT

A car panel structure, which can prevent a binder in a recess on an inner panel from overflowing during a processing process after the inner panel and an outer panel are bonded to each other, is provided. The car panel structure includes the outer panel forming an exterior of the car panel structure; and the inner panel fixed on an interior of the outer panel through the binder, wherein the inner panel has the recess recessed along a direction away from the outer panel, the recess has a binder coating portion, and the binder coating portion is vertically offset relative to a bottom surface of the recess.

### CROSS-REFERENCE TO RELATED APPLICATION

This application claims the priority benefit of China application serial no. 202310271606.8, filed on Mar. 20, 2023. The entirety of the above-mentioned patent application is hereby incorporated by reference herein and made a part of this specification.

### BACKGROUND

### Technical Field

The disclosure relates to a panel structure, and in particular to a car panel structure.

### Description of Related Art

In a car panel structure, a recess on an inner panel has a binder coating portion for accommodating a binder, and the inner panel is bonded to an outer panel through the binder. After the inner panel and the outer panel are bonded to each other, when a subsequent impregnating procedure such as electrodeposition coating is performed to apply stress to each panel, the binder in the recess is prone to overflowing. Therefore, the car panel structure needs to be improved to overcome the issue.

### SUMMARY

The disclosure provides a car panel structure, which includes an outer panel forming an exterior of the car panel structure; and an inner panel fixed on an interior of the outer panel through a binder. The inner panel has a recess recessed along a direction away from the outer panel. The recess has a binder coating portion. The binder coating portion is vertically offset relative to a bottom surface of the recess.

### BRIEF DESCRIPTION OF THE DRAWINGS

FIG. 1 is a partial cross-sectional schematic view of a car panel structure according to an embodiment of the disclosure.

FIG. 2 is a three-dimensional view of an inner panel and a binder coating portion of FIG. 1.

FIG. 3A to FIG. 3D illustrate a manufacturing process of the car panel structure of FIG. 1.

FIG. 4 is a partial cross-sectional schematic view of a car panel structure according to another embodiment of the disclosure.

FIG. 5 is a three-dimensional view of an inner panel and a binder coating portion of FIG. 4.

FIG. 6A to FIG. 6D illustrate a manufacturing process of the car panel structure of FIG. 4.

FIG. 7 is a top view of a part of an inner panel according to another embodiment of the disclosure.

FIG. 8 is a top view of another part of the inner panel of FIG. 7.

FIG. 9 is a top view of a part of an inner panel according to another embodiment of the disclosure.

FIG. 10 is a three-dimensional view of another part of the inner panel of FIG. 9.

FIG. 11 is a three-dimensional view of an inner panel according to another embodiment of the disclosure.

FIG. 12 is a cross-sectional view of the inner panel of FIG. 11 having a binder.

### DESCRIPTION OF THE EMBODIMENTS

The disclosure provides a car panel structure, which can prevent a binder in a recess on an inner panel from overflowing during a processing process after the inner panel and an outer panel are bonded to each other.

The disclosure provides a car panel structure, which includes an outer panel forming an exterior of the car panel structure; and an inner panel fixed on an interior of the outer panel through a binder. The inner panel has a recess recessed along a direction away from the outer panel. The recess has a binder coating portion. The binder coating portion is vertically offset relative to a bottom surface of the recess.

In an embodiment of the disclosure, the binder coating portion has a concave portion. The concave portion is recessed in the recess along a direction away from the outer panel.

In an embodiment of the disclosure, the concave portion is hemispherical.

In an embodiment of the disclosure, the binder coating portion has a convex portion. The convex portion protrudes from the recess along a direction close to the outer panel.

In an embodiment of the disclosure, the convex portion is hemispherical.

Based on the above, in the car panel structure of the disclosure, in the case where the binder coating portion is vertically offset downward relative to the bottom surface of the recess to form the concave portion, the recess has a greater space for accommodating the binder due to the presence of the concave portion, so the overflow of the binder can be suppressed, and a greater amount of the binder may be applied to increase the bonding strength. On the other hand, in the case where the binder coating portion is vertically offset upward relative to the bottom surface of the recess to form the convex portion, the convex portion in the recess can increase the rigidity of the bottom surface of the recess to support the outer panel, so the size of the recess can be appropriately increased while still having sufficient support strength. The recess with the increased size has a greater space for accommodating the binder, so the overflow of the binder can be suppressed. Therefore, the car panel structure of the disclosure can prevent the binder in the recess on the inner panel from overflowing during a processing process after the inner panel and the outer panel are bonded to each other.

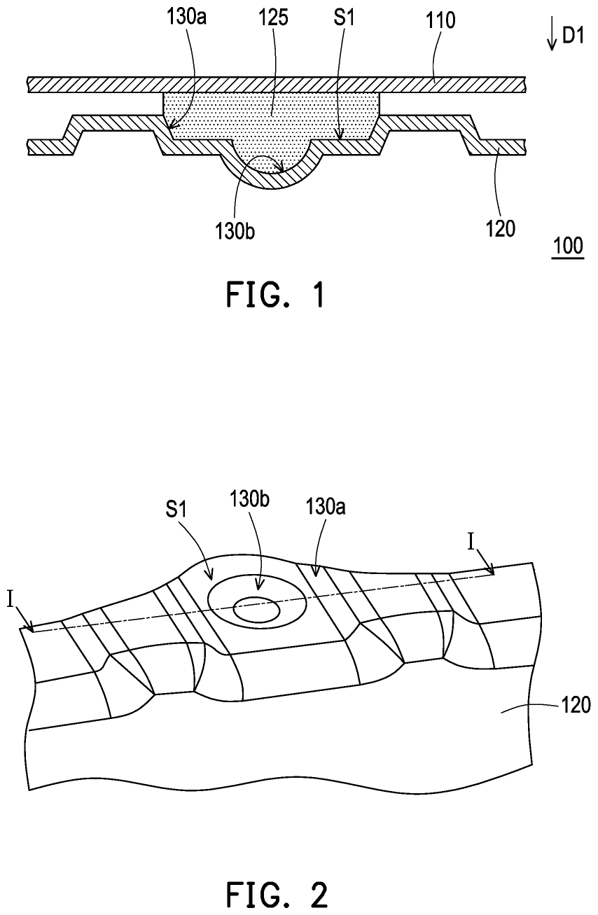

FIG. 1 is a partial cross-sectional schematic view of a car panel structure according to an embodiment of the disclosure. FIG. 2 is a three-dimensional view of an inner panel and a binder coating portion of FIG. 1. FIG. 1 corresponds to a line I-I of FIG. 2. Please refer to FIG. 1 and FIG. 2. A car panel structure 100 of the embodiment includes an outer panel 110 and an inner panel 120. The outer panel 110 forms an exterior of the car panel structure 100. The inner panel 120 is fixed on an interior of the outer panel 110 through a binder 125. The outer panel 110 is, for example, a hood skin, and the inner panel 120 is, for example, a hood frame, but the disclosure is not limited thereto.

Specifically, the inner panel 120 has a recess 130a recessed along a direction D1 away from the outer panel 110. The recess 130a has a binder coating portion 130b and is configured to accommodate the binder 125. The binder coating portion 130b of the embodiment is, for example, integrally formed and connected to the inner panel 120. In addition, the binder coating portion 130b is vertically offset downward relative to a bottom surface S1 of the recess 130a along the direction (that is, the direction D1) away from the outer panel 110 to form a concave portion. Under the configuration, the recess 130a has a greater space for accommodating the binder 125 due to the presence of the concave portion (the binder coating portion 130b). Therefore, during a processing process after the inner panel 120 and the outer panel 110 are bonded to each other, the binder 125 can be prevented from being compressed and overflowing due to the inner panel 120 and the outer panel 110 being forced close to each other, thereby preventing the binder 125 remaining in the recess 130a from being insufficient after the inner panel 120 and the outer panel 110 are reset, and a greater amount of the binder 125 may be applied to increase the bonding strength.

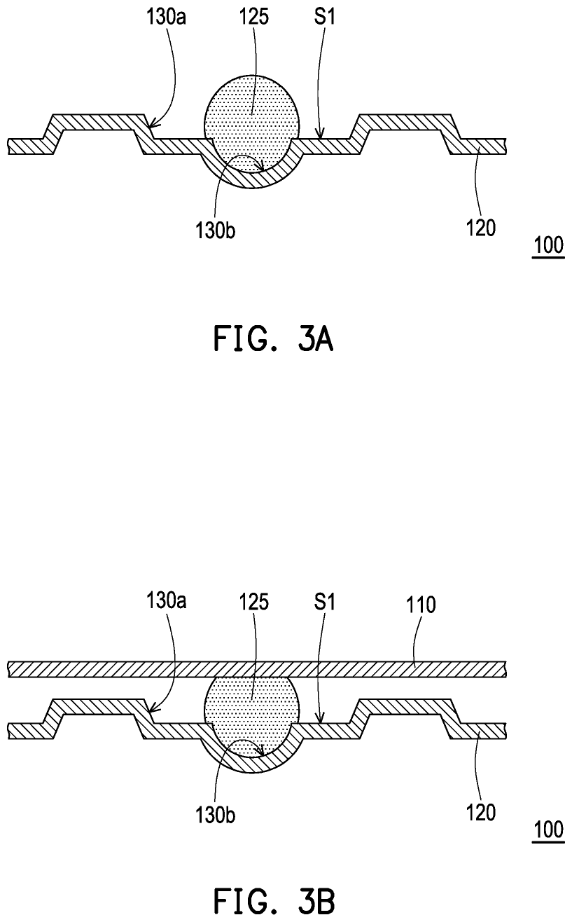

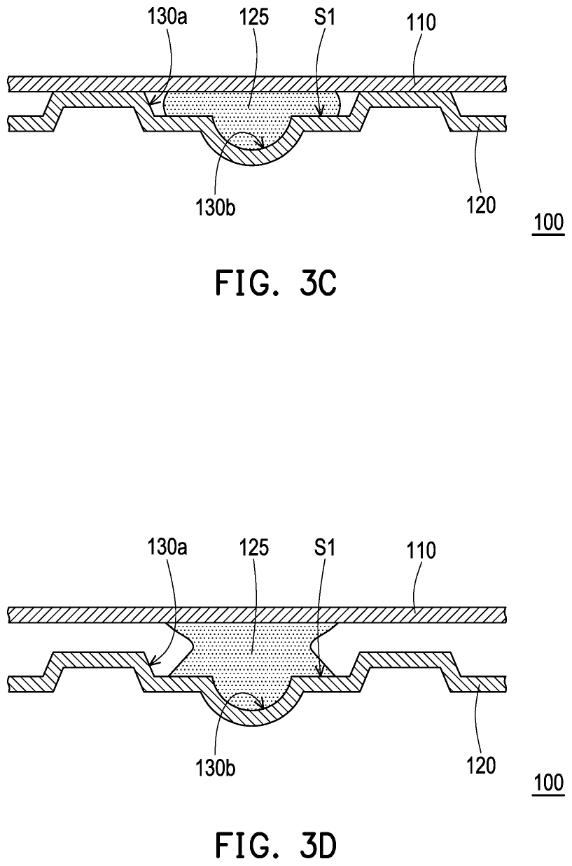

The distribution state of the binder 125 shown in FIG. 1 is only for illustration and will be described in more detail below with reference to the drawings. FIG. 3A to FIG. 3D illustrate a manufacturing process of the car panel structure of FIG. 1. Specifically, after the binder 125 is applied to the inner panel 120 as shown in FIG. 3A and the outer panel 110 and the inner panel 120 are joined through the binder 125 as shown in FIG. 3B, the inner panel 120 and the outer panel 110 may be forced close to each other due to subsequent processing, so that the binder 125 is compressed as shown in FIG. 3C. Since the recess 130a has a greater space for accommodating the binder 125 due to the presence of the concave portion (the binder coating portion 130b) as mentioned above, the binder 125 does not overflow outside the recess 130a even in the state shown in FIG. 3C. Therefore, in the state where the inner panel 120 and the outer panel 110 are reset as shown in FIG. 3D, there is still sufficient binder 125 in the recess 130a, and the binder 125 having excessive gaps will not be formed due to insufficient binder 125 remaining in the recess 130a.

In the embodiment, the concave portion (the binder coating portion 130b) is, for example, hemispherical rather than stepped. Accordingly, the force acting on the concave portion (the binder coating portion 130b) can be dispersed without easily causing structural deformation, and cracks are less likely to occur during press forming. In other embodiments, the concave portion (the binder coating portion 130b) may have other appropriate shapes, which is not limited by the disclosure.

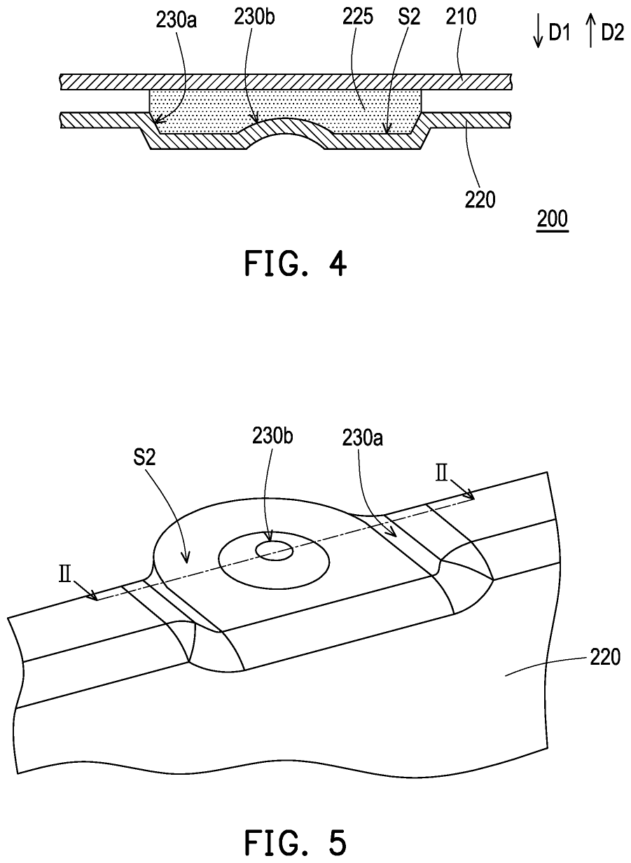

FIG. 4 is a partial cross-sectional schematic view of a car panel structure according to another embodiment of the disclosure. FIG. 5 is a three-dimensional view of an inner panel and a binder coating portion of FIG. 4. FIG. 4 corresponds to a line II-II of FIG. 5. Please refer to FIG. 4 and FIG. 5. A car panel structure 200 of the embodiment includes an outer panel 210 and an inner panel 220. The outer panel 210 forms an exterior of the car panel structure 200. The inner panel 220 is fixed on an interior of the outer panel 210 through a binder 225. The outer panel 210 is, for example, a hood skin, and the inner panel 220 is, for example, a hood frame, but the disclosure is not limited thereto.

Specifically, the inner panel 220 has a recess 230a recessed along a direction D1 away from the outer panel 210. The recess 230a has a binder coating portion 230b and is configured to accommodate the binder 225. The binder coating portion 230b of the embodiment is, for example, integrally formed and connected to the inner panel 220. In addition, the binder coating portion 230b is vertically offset upward relative to a bottom surface S2 of the recess 230a along a direction (that is, a direction D2) close to the outer panel 210 to form a convex portion. Under the configuration, the convex portion (the binder coating portion 230b) in the recess 230a can increase the rigidity of the bottom surface S2 of the recess 230a to support the outer panel 210, so the size of the recess 230a can be appropriately increased while still having sufficient support. The recess 230a with the increased size has a greater space for accommodating the binder 225. Therefore, during a processing process after the inner panel 220 and the outer panel 210 are bonded to each other, the binder 225 can be prevented from being compressed and overflowing due to the inner panel 220 and the outer panel 210 being forced close to each other, thereby preventing the binder 225 remaining in the recess 230a from being insufficient after the inner panel 220 and the outer panel 210 are reset, and a greater amount of the binder 225 may be applied to increase the bonding strength.

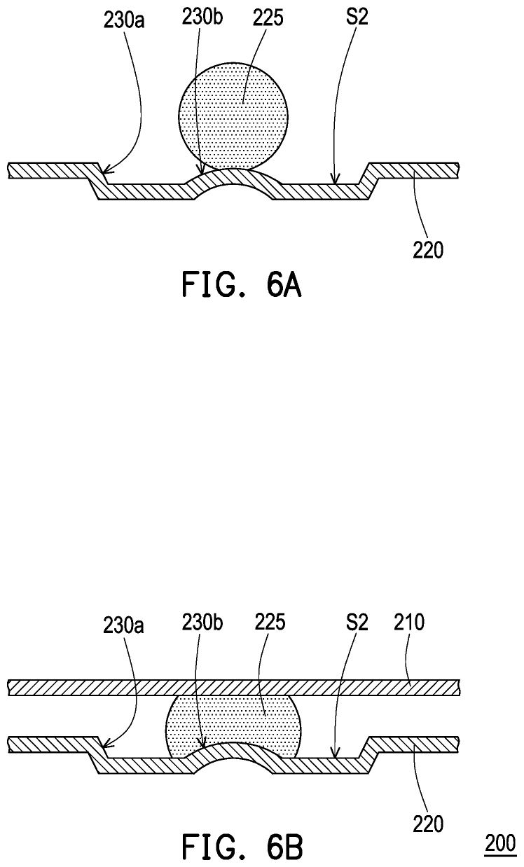

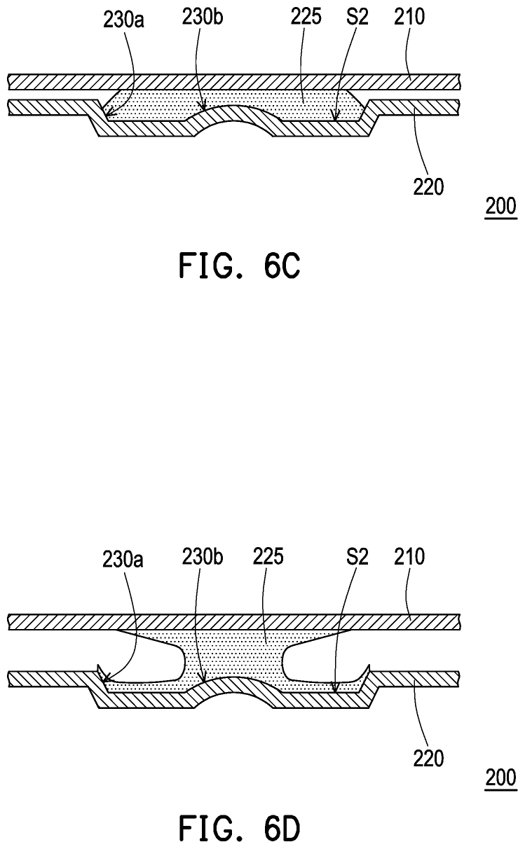

The distribution state of the binder 225 shown in FIG. 4 is only for illustration and will be described in more detail below with reference to the drawings. FIG. 6A to FIG. 6D illustrate a manufacturing process of the car panel structure of FIG. 4. Specifically, after the binder 225 is applied to the inner panel 220 as shown in FIG. 6A and the outer panel 210 and the inner panel 220 are joined through the binder 225 as shown in FIG. 6B, the inner panel 220 and the outer panel 210 may be forced close to each other due to subsequent processing, so that the binder 225 is compressed as shown in FIG. 6C. Since the recess 230a can be appropriately increased in size due to the presence of the convex portion (the binder coating portion 230b) as mentioned above to have a greater space for accommodating the binder 225, the binder 225 does not overflow outside the recess 230a even in the state shown in FIG. 6C. Therefore, in the state where the inner panel 220 and the outer panel 210 are reset as shown in FIG. 6D, there is still sufficient binder 225 in the recess 230a, and the binder 225 having excessive gaps will not be formed due to insufficient binder 225 remaining in the recess 230a.

In the embodiment, the convex portion (the binder coating portion 230b) is, for example, hemispherical rather than stepped. Accordingly, the force acting on the convex portion (the binder coating portion 230b) can be dispersed without easily causing structural deformation, and cracks are less likely to occur during press forming. In addition, the binder 225 can be uniformly diffused into the recess 230a along the spherical shape of the convex portion (the binder coating portion 230b). In other embodiments, the convex portion (the binder coating portion 230b) may have other appropriate shapes, which is not limited by the disclosure.

The disclosure does not limit the form of the car panel structure, which is illustrated below through the drawings.

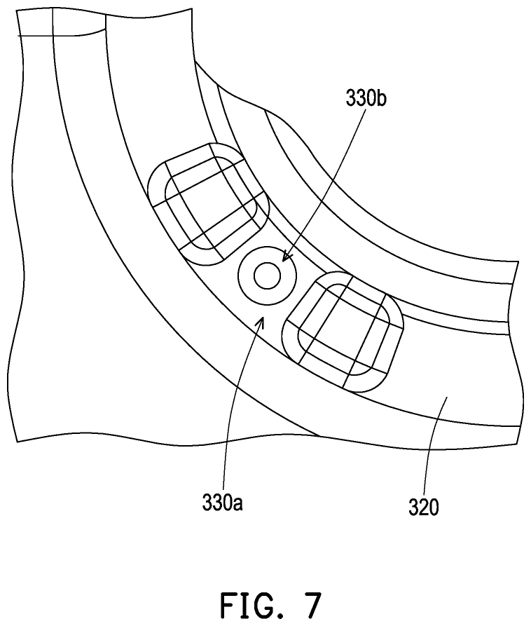

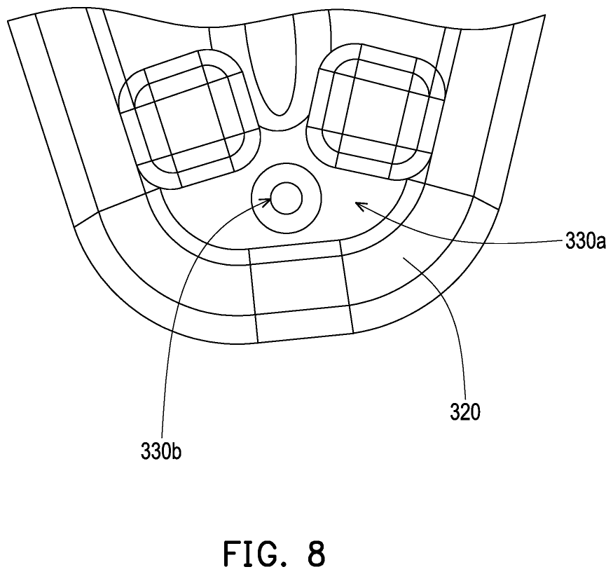

FIG. 7 is a top view of a part of an inner panel according to another embodiment of the disclosure. FIG. 8 is a top view of another part of the inner panel of FIG. 7. The shapes of an inner panel 320 and a recess 330a thereof and a binder coating portion 330b of the embodiment shown in FIG. 7 and FIG. 8 are different from the shapes of the inner panel 120 and the recess 130a thereof and the binder coating portion 130b of the embodiment shown in FIG. 2. The recess 330a extends in a slightly curved shape along with the overall shape of the inner panel 320. The binder coating portion 330b is formed into a concave portion and has a function similar to the binder coating portion 130b of the embodiment shown in FIG. 2, which will not be described again.

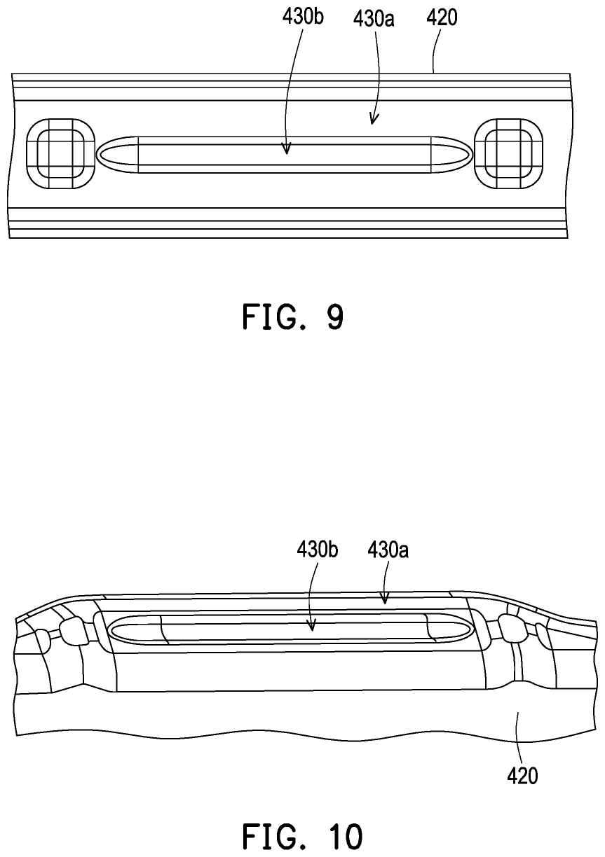

FIG. 9 is a top view of a part of an inner panel according to another embodiment of the disclosure FIG. 10 is a three-dimensional view of another part of the inner panel of FIG. 9. The shapes of an inner panel 420 and a recess 430a thereof and a binder coating portion 430b of the embodiment shown in FIG. 9 and FIG. 10 are different from the shapes of the inner panel 120 and the recess 130a thereof and the binder coating portion 130b of the embodiment shown in FIG. 2. The binder coating portion 430b is elongated and extends in an extension direction of the recess 430a. The binder coating portion 430b is formed into a concave portion and has a function similar to the binder coating portion 130b of the embodiment shown in FIG. 2, which will not be described again.

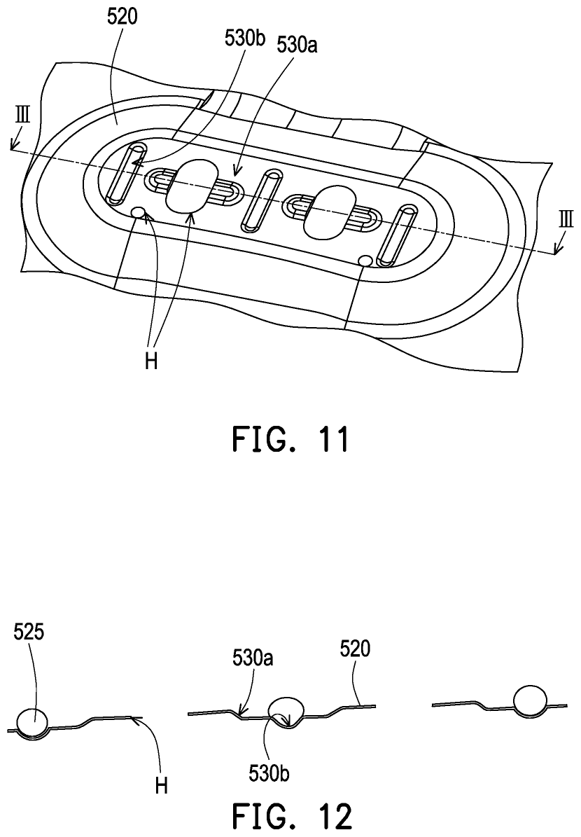

FIG. 11 is a three-dimensional view of an inner panel according to another embodiment of the disclosure. FIG. 12 is a cross-sectional view of the inner panel of FIG. 11 having a binder (a binder 525). FIG. 12 corresponds to a line III-III of FIG. 11. The shapes of an inner panel 520 and a recess 530a thereof and a binder coating portion 530b of the embodiment shown in FIG. 11 and FIG. 12 are different from the shapes of the inner panel 120 and the recess 130a thereof and the binder coating portion 130b of the embodiment shown in FIG. 2. The binder coating portion 530b is elongated and is formed in the recess 530a together with a drainage hole H. The binder coating portion 530b is formed into a concave portion and has a function similar to the binder coating portion 130b of the embodiment shown in FIG. 2, which will not be described again.

In summary, in the car panel structure of the disclosure, in the case where the binder coating portion is vertically offset downward relative to the bottom surface of the recess to form the concave portion, the recess has a greater space for accommodating the binder due to the presence of the concave portion, so the overflow of the binder can be suppressed, and a greater amount of the binder may be applied to increase the bonding strength. On the other hand, in the case where the binder coating portion is vertically offset upward relative to the bottom surface of the recess to form the convex portion, the convex portion in the recess can increase the rigidity of the bottom surface of the recess to support the outer panel, so the size of the recess can be appropriately increased while still having sufficient support strength. The recess with the increased size has a greater space for accommodating the binder, so the overflow of the binder can be suppressed. Therefore, the car panel structure of the disclosure can prevent the binder in the recess on the inner panel from overflowing during the processing process after the inner panel and the outer panel are bonded to each other.

Finally, it should be noted that the above embodiments are only configured to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A car panel structure, comprising:
an outer panel, forming an exterior of the car panel structure; and
an inner panel, fixed on an interior of the outer panel through a binder, wherein
the inner panel has a recess recessed along a direction away from the outer panel,
the recess has a binder coating portion, and the binder coating portion is vertically offset relative to a bottom surface of the recess.

2. The car panel structure according to claim 1, wherein:
the binder coating portion has a concave portion, and the concave portion is recessed in the recess along a direction away from the outer panel.

3. The car panel structure according to claim 2, wherein:
the concave portion is hemispherical.

4. The car panel structure according to claim 1, wherein:
the binder coating portion has a convex portion, and the convex portion protrudes from the recess along a direction close to the outer panel.

5. The car panel structure according to claim 4, wherein:
the convex portion is hemispherical.
